(19) United States
(12) Patent Application Publication
(10) Pub. No.: US 2013/0298667 A1
(43) Pub. Date: Nov. 14, 2013

(54) Apparatus and Method for Capacitive Fill Level Measurement

(71) Applicants: Gerd Bechtel, Steinen (DE); Armin Wernet, Rheinfelden (DE); Kaj Uppenkamp, Wehr (DE)

(72) Inventors: Gerd Bechtel, Steinen (DE); Armin Wernet, Rheinfelden (DE); Kaj Uppenkamp, Wehr (DE)

(21) Appl. No.: 13/980,451

(22) PCT Filed: Dec. 9, 2011
(86) PCT No.: PCT/EP2011/072259

§ 371 Date: Jul. 18, 2013

(30) Foreign Application Priority Data
Jan. 26, 2011 (DE) 10 2011 003 158.8

(51) Int. Cl. G01F 23/26

(52) U.S. Cl. CPC G01F 23/261
USPC 73/304 C

(57) ABSTRACT

The invention relates to an apparatus for capacitive determining and/or monitoring at least of fill level of a medium in a container, comprising a probe unit having at least one probe electrode, and an electronics unit, which supplies at least the probe electrode with an electrical, transmitted signal, and receives and evaluates an electrical, response signal from the probe unit. Besides relating to an apparatus, the invention also relates to a corresponding method. The invention is distinguished by features including that an electronics unit supplies the probe electrode at least at times by means of a frequency sweep with a transmitted signal, which has a plurality of discrete frequencies following one another within a predeterminable frequency band, that the electronics unit, based on the frequency sweep, ascertains a measuring frequency optimal for present application parameters, and that the electronics unit determines fill level from the response signal belonging to the optimal measuring frequency.

The present invention relates to apparatus and method for capacitive determining and/or monitoring at least of the fill level of a medium in a container using a probe unit. Besides the fill level, for example, the electrical conductivity and/or the permittivity of the medium are determinable, or it can be monitored whether accretion has formed on the probe unit.

Used frequently for fill level measurement in liquid media are measuring devices utilizing the capacitive measuring principle. Such measuring devices comprise a probe with, as a rule, a rod-shaped sensor electrode and, in given cases, a guard electrode for improving measurement in the case of accretion formation on the probe. The fill level of the medium is ascertained from the capacitance of the capacitor formed of the probe electrode and the container wall or a second electrode, wherein an alternating voltage is placed on the probe electrode. Depending on the conductivity of the medium, the medium and/or a probe insulation forms the dielectric of the capacitor. The guard electrode lies at the same potential as the probe electrode and surrounds the probe electrode at least sectionally coaxially. A probe with guard is described, for example, in DE 3212434 C2, and a probe without guard is shown in WO 20061034959 A2. Capacitive probes for continuous fill level determination or for limit level measurement are produced and sold by the assignee in different embodiments and with different probe lengths.

In the case of capacitive probes, there is the problem that the frequency of the applied alternating voltage is, for reason of resonance effects, to be chosen smaller, the longer the probe is. A high measuring frequency, however, increases accretion insensitivity. Accretion does, however, play a role equally in the case of short and long probes. In order to provide an electronics unit compatible for probes of any length, consequently, most often, a measuring frequency is used, which is equally suitable for all probe lengths. This ends up being, however, below the frequency optimal for shorter probes.

A further problem arises in the case of media with conductivity values, which lie in a transitional region between a permittivity dependent and a permittivity independent measuring range. The fill level is not reliably determinable in this range, so that these media are excluded from capacitive fill level measurement.

An object of the invention is to expand the range of applications for capacitive fill level measurement.

The object is achieved by an apparatus for capacitive determining and/or monitoring at least of the fill level of a medium in a container, comprising a probe unit having at least one probe electrode, and an electronics unit, which supplies at least the probe electrode with an electrical, transmitted signal, and receives and evaluates an electrical, response signal from the probe unit, wherein the electronics unit supplies the probe electrode at least at times by means of a frequency sweep with a transmitted signal, which has a plurality of discrete frequencies following one another within a predeterminable frequency band, wherein the electronics unit, based on the frequency sweep, ascertains a measuring frequency optimal for present application parameters, and wherein the electronics unit determines fill level from the response signal belonging to the optimal measuring frequency.

The object is furthermore achieved by a method for capacitive determining and/or monitoring at least of the fill level of a medium in a container with a probe unit having at least one probe electrode. The method is distinguished by features including that the probe electrode is supplied at least at times by means of a frequency sweep with an electrical, transmitted signal, which has a plurality of discrete exciter frequencies following one another within a predeterminable frequency band, that based on the frequency sweep a measuring frequency optimal for present application parameters is ascertained, and that fill level is determined from a response signal of the probe electrode belonging to the optimal measuring frequency.

The frequency sweep also makes the otherwise excluded conductivity range for the capacitive measuring between 1 and 100 μS/cm accessible for measuring. This is done by detecting a measuring frequency, in the case of which the response signal displays a unique, especially linear, dependence on fill level. Also in the case of unproblematic conductivity values, the measuring performance is improved compared to the state of the art, since the frequency sweep enables measuring with the measuring frequency optimal for the particular application. An optimal measuring frequency means, for example, that always the maximum possible accretion insensitivity is present for any particular probe geometry. At the same time, errors in the fill-level display because of non-linear behavior of the response signal are as small as possible at the optimal measuring frequency. The response signal at the measuring frequency optimal for the present application leads to determining fill level with smallest possible measurement error.

Because of the variable measuring frequency, it is no longer required that the user choose as a function of the respective application earlier between two measurement frequencies and, thus, between two corresponding electronic units, or check whether the capacitive measuring principle is at all applicable. The manufacturer no longer has to compromise between providing a broadly applicable measuring device and best possible fill level measurement. The electronics unit embodied for performing a frequency sweep is universally applicable for any applications, since the measuring frequency is matched to the application parameters, even when such parameters change.

The probe electrode is supplied with a transmitted signal in the form of an alternating voltage. While in the state of the art a certain frequency is predetermined, according to the invention, the frequency of the transmitted signal varies within a certain frequency band. A frequency sweep is performed. In other words, the excitation is done with a plurality of frequencies following one after the other. The step width of the frequencies lies, for example, in each case, between 10 kHz and 1 MHz and can vary over the frequencies of the frequency band. The frequency band includes preferably a number of orders of magnitude.

For example, a frequency band can extend from 10 kHz to 10 MHz. The response signal, which the electronics unit receives as response to the supplying of the probe electrode with the transmitted signal, is an electrical current signal, which, for example, is converted via a resistor into a corresponding voltage signal and digitized for evaluation.

The response signal is influenced by, among other things, the capacitance of the capacitor formed by probe electrode, counter electrode, or container, medium and, in given cases, an insulation of the probe electrode. Since the capacitance depends on fill level, fill level is determinable from the response signal. In such case, used for evaluating fill level is the response signal registered at the optimal measuring frequency. The optimal measuring frequency is determined by means of an algorithm. For ascertaining the capacitance, an evaluation algorithm is implemented in the electronics unit, which correspondingly evaluates the response signal at the optimal measuring frequency. The evaluation algorithm for a response signal at optimal measuring frequency does not differ from known evaluating algorithms for evaluating response signals registered when supplying the probe electrode with a fixed frequency. Besides the algorithm for determining and/or monitoring fill level, as well as for the finding the optimal measuring frequency, preferably there are implemented in the electronics unit other algorithms, which ascertain other information from the signal in response to the frequency sweep.

The response signal is characteristically for the present application, i.e., for example, for the existing environmental parameters, such as the fill level, the physical properties of the medium, or accretion on the probe unit, and for the particular embodiment of the probe, especially the probe length. All variables are to be subsumed under the terminology, “application parameters that establish the optimal measuring frequency”. The optimal measuring frequency, in the case of which fill level is determinable most accurately, is ascertainable from the response signal, or by means of characteristic variables won from the response signal.

In a first embodiment of the solution of the invention, the probe electrode is supplied continuously with the optimal measuring frequency for determining and/or monitoring fill level. If changes of the application parameters are not expected, supplying the probe electrode with the ascertained optimal measuring frequency is advantageous. The probe electrode, for the finding the optimal measuring frequency, is supplied at least at start-up with a frequency sweep, in order to ascertain the measuring frequency optimal for the present application. The fill level is, in this case, only initially determined by means of the frequency sweep. Subsequently, the probe electrode is supplied with a transmitted signal having the ascertained optimal measuring frequency and fill level determined and/or monitored from the response signal obtained at this frequency. For checking whether the optimal measuring frequency has changed, at certain intervals, additional frequency sweeps can be performed.

In an alternative embodiment, the probe electrode is always supplied with frequency sweeps following one another and fill level determined and/or monitored based on the optimal measuring point of the respective frequency sweep. The application of frequency sweeps following one another offers the advantage that the measuring point in the case of a change of an application parameter is matched immediately to the new conditions. A continued operation of the measuring device with frequency sweep offers additionally the opportunity to determine or monitor other process variables or parameters.

In a further development of the method of the invention, for each frequency of the transmitted signal, from the associated response signal, the value of at least one characteristic variable of the response signal dependent on present application parameters and/or at least one dependent variable derived from at least one characteristic variable is ascertained, stored, and checked, when, for the frequency, at least one of the respectively ascertained characteristic variables and/or dependent variables fulfills at least one predetermined criterion for the presence of the optimal measuring frequency. The terminology, characteristic variable, means a directly measurable variable determinable directly from the response signal. A dependent variable is, in such case, a variable, which can be calculated from at least one directly measurable characteristic variable, for example, also taking into consideration further variables, such as probe parameters or known properties of the medium. The dependent variable can, thus, also be the process variable to be determined, e.g fill level. The evaluation algorithm implemented in the electronics unit for the finding the optimal measuring point evaluates at least one characteristic variable obtained directly from the response signal, and/or at least one dependent variable derived, especially calculated, therefrom. Characteristic variables and dependent variables, as a rule, assume values, which, on the one hand, depend on the measuring frequency and, on the other hand, more or less strongly on parameters of the present application. Such parameters are, for example, the conductivity or the permittivity of the medium, the probe geometry, especially the probe length, the installation geometry, or accretion of medium forming on the probe unit. By means of determined criteria, consequently, that frequency is ascertained, whose associated response signal most accurately represents fill level.

A further development of the invention provides that especially the phase shift between the transmitted signal and the response signal and/or the admittance, or the magnitude of the response signal, is/are ascertained as characteristic variable, and/or that especially the capacitance and/or fill level of the medium is/are ascertained as dependent variable derived from the characteristic variable.

Another further development of the method provides that a criterion for exceeding- or subceeding a limit value is the presence of an extreme point, the assuming of a certain value or the presence of a certain slope. Analysis of recorded envelope curves, respectively data pairs, occurs by means of predetermined algorithms, which check certain criteria. The criteria are especially to be applied to the phase curve or the fill level- or capacitance curve, which was recorded versus all frequencies of the sweep. A criterion is, for example, the presence of a positive or negative slope, or the presence of a high- or low point in the curve representing capacitance or fill level versus frequency. A further criterion is, for example, whether the phase shift between input- and output voltage, i.e. between transmitted signal and response signal, or a voltage corresponding to the response signal, assumes a desired value of, ideally, −90°. Besides the criteria for the characteristic- and/or dependent variables, also known parameters of the medium, for example, the electrical conductivity, can be taken into consideration for evaluation.

In an advantageous embodiment of the method, a criterion is that the frequency, in the case of which the associated value of one of the characteristic variables and/or dependent variables fulfills a certain criterion, is the highest frequency, for which this criterion is fulfilled. The higher the measuring frequency, the smaller is the accretion sensitivity. Therefore, the highest possible frequency is used as optimal measuring frequency.

In an embodiment of the invention, the time curve of at least one of the characteristic variables and/or dependent variables ascertained at a certain frequency is monitored. In this way, for example, accretion formation on the probe unit is detectable and compensatable. The monitoring of the time curve can also be performed for a plurality of frequencies.

In a further development of the method of the invention, a breaking off of at least one part of the probe unit is detected by monitoring the frequency, at which resonances occur in the response signal. Resonances in the response signal are recognizable, for example, by a positive slope in the capacitance- or fill-level curve in the upper region of the passed through, frequency band and relatively high values of capacitance or fill level.

Another further development is that, based on the frequency sweep, at least one present application parameter, preferably a parameter of the medium, especially the permittivity and/or the electrical conductivity of the medium, and/or the presence or the quantity of accretion of medium on the probe unit, is determined. For determining parameters of the medium, in such case, a known probe- and installation geometry is required.

Advantageously, sensor parameters and/or parameters of the medium are taken into consideration in performing and/or evaluating the frequency sweep, for example, in choosing the frequency band for the frequency sweep and/or in selecting the criterion and/or in evaluating accretion or a parameter of the medium.

The invention will now be explained in greater detail based on the appended drawing, the figures of which show as follows, wherein the apparatus is embodied to perform the method in all its embodiments:

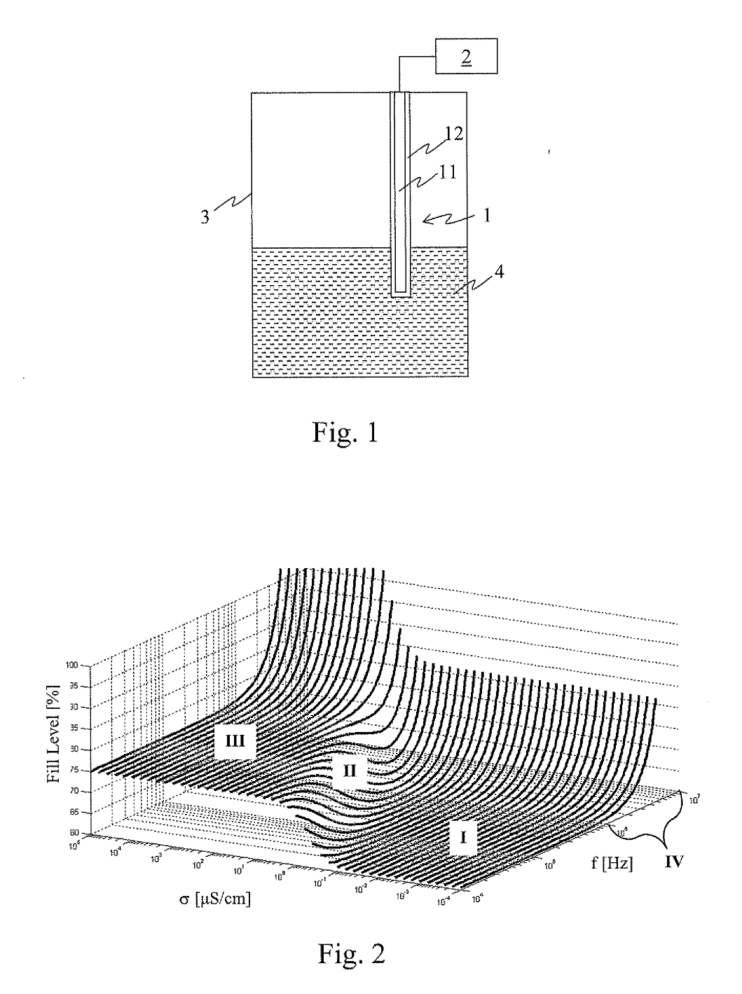

FIG. 1 a capacitive measuring device with a probe unit;

FIG. 2 a three-dimensional representation of the dependence of the ascertained fill level on electrical conductivity and measuring frequency; and

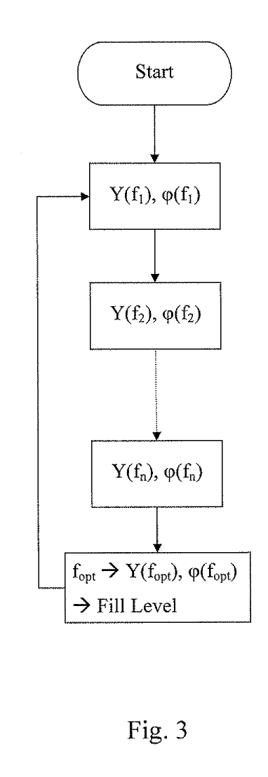

FIG. 3 a flow diagram of an embodiment of the method for fill level measurement.

FIG. 1 shows an apparatus for capacitive determination at least of fill level of a medium 4 in a container 3. The apparatus includes a probe unit 1, which protrudes inwardly into the container 3. In this embodiment the probe unit 1 includes a probe electrode 11 and an insulation 12, which surrounds the probe electrode 11 completely and electrically insulates from the medium 4, here liquid medium 4. The counter electrode for capacitive measuring is formed by the wall of the container 3. It can, however, equally be a second probe introduced into the container 3 and including a reference electrode. With such a probe unit 1, the fill level of the medium 4 is continuously determinable. The invention can, however, also be used in the case of apparatuses for capacitive registering of a limit level, which are mounted at a certain height and especially flushly into the wall of the container 3. In an embodiment, the probe unit 1 further includes a guard electrode, which coaxially surrounds the probe electrode 11 at least in-a region near the process connection and is likewise surrounded by insulation.

The variables determinable with an apparatus of the invention include, besides fill level, for example, the electrical conductivity and/or the permittivity of the medium 4, or accretion formation on the probe unit 1.

The electronics unit 2 arranged outside of the container 3 supplies the probe electrode 11 with an electrical signal in the form of an alternating voltage and receives an electrical response signal from the probe electrode 11. The response signal is, as a rule, an electrical current signal, which is converted via a resistor into a corresponding voltage signal. This is preferably fed to the analog/digital converter of a microcontroller in the electronics unit 2. In case a guard electrode is present, this receives the same transmitted signal as the probe electrode 11. The parameters of the response signal, such as, for example, the phase shift relative to the transmitted signal or the amplitude, depend on, among others things, how much of the probe unit 1 is surrounded by medium 4, so that fill level of the medium 4 is continuously determinable and monitorable based on the response signal. Another dependence results from the electrical conductivity σ and the dielectric constant ε, respectively permittivity, of the medium. For the case, in which the medium 4 is not conductive, no insulation is required and it is the capacitance between probe electrode 11 and container 3 with the medium 4 as dielectric that is measured. For the case, in which the medium 4 has at least a slight conductivity σ, additionally the capacitance between probe electrode 11 and medium 4 is measured, wherein the insulation 12 represents the dielectric capacitor formed by the from probe electrode 11 and medium 4. In the case of a high conductivity σ, only the insulated capacitance is measured, so that the measuring in such case is independent of the value of the dielectric constant ε of the medium.

FIG. 2 shows the dependence of fill level of the medium 4 on the electrical conductivity σ of the medium and on the measuring frequency f. The permittivity is, in each case, equal for the illustrated curves. Four regions are recognizable:

Region I: The electrical conductivity a of the medium 4 is small and the measuring frequency f lies in the low to middle range of the illustrated frequency band of 10 kHz to 10 MHz. The calculated fill level depends on the permittivity of the medium 4, wherein this dependence is eliminatable by adjustment in the case of uncovered and fully covered probe unit 1. The fill level is exactly determinable in this region.

Region II: Transitional region between permittivity dependent and permittivity independent measuring. The electrical conductivity a increases and the resistance of the medium 4 correspondingly decreases. Small changes in the conductivity σ can bring about a large change in the indicated fill level, so that, in the state of the art, no reliable capacitive fill level measurement is possible in this region.

Region III: The electrical conductivity a of the medium 4 is so large that only the insulation capacitance is measured. The measuring is independent of the permittivity of the medium 4 and fill level is exactly determinable.

Region IV: From, for instance, one megahertz measuring frequency, there begins in this example the resonance range. This arises in the case of all conductivity values σ. The limit frequency, which displays the beginning the resonance range, is lower, the longer the probe unit 1 is. In the resonance range, no fill level measurement is possible, since there is no longer a linear relationship between measured capacitance and fill level.

If one considers fill level as a function of conductivity a in the case of a certain frequency f, e.g. in the case of 10 kHz, it can be seen that, in a certain range of conductivity values σ, fill level is not determinable. The position of this range shifts as a function of frequency f. While with a fixed measuring frequency f, thus, always some conductivity values σ are excluded from the measuring, with a frequency sweep, always at least one frequency f can be detected, in the case of which fill level determination is reliably possible, i.e. one is in Region I or III.

For this, the measuring frequency f is successively increased or decreased within a certain frequency band, which preferably a includes number of orders of magnitude, for example, from 10 kHz to 10 MHz. In this way, a plurality of measurement points are found, which are available for evaluation. In such case, not only evaluation in reference to fill level based on the response signal taken at the measuring frequency optimal is possible, but, instead, from the curves of the characteristic variables with frequency, other variables can be determined or monitored.

By means of a frequency sweep, it can, for example, be detected, at which limit frequency the resonance range, Region IV, begins. For fill level determination, thus, a measured value can be taken into consideration, which was recorded at a relatively high frequency f and, thus, has a high accretion insensitivity, and which simultaneously represents fill level correctly, since it lies safely below the resonance range. With the frequency sweep, always an optimum measuring point can be found, i.e. a frequency f and the characteristic variables and/or therefrom determined dependent variables ascertained at this frequency f, so that the determining of fill level occurs with minimum measurement error.

FIG. 3 shows a flow diagram of a simple embodiment of the method for determining and/or monitoring fill level of a medium. In this embodiment, recorded and stored for evaluation as the measured values, respectively characteristic variables, are at least the phase shift φ between transmitted signal and response signal and the admittance Y. Both variables serve for calculating the capacitance and, thus, for determining the fill level. The optimal measuring frequency fₒₚₜ for determining fill level is ascertained from phase shift φ(fᵢ) and admittance Y(fᵢ) as a function of frequency f_{i,}.

At a first frequency f₁, from the response signal, the admittance Y(f₁) and the phase shift φ(f₁) between response signal and transmitted signal are determined as characteristic variables. Then the probe electrode 11 is supplied with a transmitted signal having a second frequency f₂ and, in turn, the admittance Y(f₂) and the phase shift φ(f₂) determined. This is performed for all n frequencies of the predetermined frequency band. The characteristic variables Y(fᵢ), φ(fᵢ) are, in each case, stored, so that, at the end of the frequency sweep, the admittance Y and the phase shift φ will be present as a function of frequency f.

By means of a suitable evaluation algorithm, the measuring frequency fₒₚₜ optimal for the present application is ascertained from the recorded characteristic variables Y, φ. For evaluation, also dependent variables can be calculated from the parameters, especially taking additional parameters into consideration. Preferably, capacitance is calculated from the characteristic variables Y, φ and such is taken into consideration alternatively or supplementally to at least one of the characteristic variables for the evaluation.

For example, it is checked, at which frequencies the value φ of the phase shift lies ideally at −90°, since this criterion be must fulfilled when assuming a purely capacitive arrangement of probe unit 1, medium 4 and container 3. Preferably, furthermore, the slope of the capacitance curve is ascertained at least at the points, where the criterion for the phase shift φ is fulfilled. From a large positive slope at high frequencies, the beginning of the resonance range can be recognized. The optimal measuring frequency fₒₚₜ lies just below the resonance range, in order to assure a good accretion insensitivity. In an advantageous embodiment is, consequently, the optimal measuring frequency fₒₚₜ is the highest frequency, at which the capacitance has a zero slope or a positive slope lying under a certain limit value and the value φ of the phase shift amounts to −90°. The corresponding values of admittance Y, phase shift φ and/or capacitance form with the optimal measuring frequency fₒₚₜ the optimal measuring point. Fill level is determined at the optimal measuring point.

Additionally, for ascertaining the optimal measuring point and determining fill level, other evaluations can be performed, e.g. in reference to accretion formation or breaks in the probe. Corresponding embodiments of the method are described below. After evaluation of the response signal recorded with a frequency sweep with reference to all variables to be determined, a new frequency sweep is begun in this embodiment.

The frequency sweep is either continuously repeated, or one frequency sweep leads to a suitable measuring frequency, which is used subsequently for fill level measurement. In the latter case, the electronics unit 2, after an initial frequency sweep, supplies the probe electrode 11 with the detected optimal measuring frequency fₒₚₜ and determines fill level from the corresponding response signal. For example, the phase φ and the admittance Y are measured and from the phase φ and the admittance Y the capacitance is determined and from the capacitance the fill level. In certain intervals or in the case of a change of an application parameter, e.g. accretion formation, then a new frequency sweep is performed and the measuring frequency is, in given cases, adapted for changed application conditions. If a frequency sweep is performed, fill level can also be ascertained directly based on the response signal during the frequency sweep.

In an embodiment of the method, supplementally the dielectric constant of the medium is ascertained. The dielectric constant is determinable for media having conductivity values, which lie in Region I, i.e. in the permittivity-dependent region. For this, a tuning in different media is required. This can be carried out for a particular probe geometry in the factory or at start-up of the measuring device. The dielectric constant present in measurement operation is then ascertainable based on a stored relationship between the response signal and the frequency sweep, for example, from the capacitance curve.

In an embodiment of the method, the conductivity of the medium is ascertained. The capacitance is dependent on conductivity in Region II. The conductivity is determined, for example, from the position of the low point before the resonance related rise of the capacitance- or fill-level curve by comparing the frequency, at which the low point occurs, with data in a calibration.

In an additional embodiment of the method, the probe unit 1 is monitored for breakage. Especially, in the case of probe units 1, which because of the long probe length are partially embodied as cable, a breaking off of the probe unit 1 or at least a part thereof can occur. Such breakage leads to a decrease of the inductance of the probe unit 1. The limit frequency, after which resonances occur, shifts, consequently, in the case of a breaking off, to higher frequencies. The limit frequency measurable in the case of the empty calibration of the probe unit 1 corresponds to the maximum possible limit frequency for the completely undamaged probe unit 1. By monitoring the limit frequency, for example, by recording and evaluating the time curve of the limit frequencies ascertained in each execution of the frequency sweep, or by a comparison of the currently present limit frequency with the limit frequency measured in the case of the empty calibration of the probe unit 1, a breaking off is, thus, detectable.

In an additional embodiment of the method, accretion formation on the probe unit is detected by means of continuingly executed frequency sweep and the effects arising, in given cases, therefrom are compensated. A criterion for the occurrence of accretion is, for example, the presence of a negative slope in the capacitance curve recorded with a frequency sweep. If it is known that the conductivity lies above the transition Region II, negative slopes can point unequivocally to accretion. If this information is not known, at least one additional criterion is required for distinguishing between a measuring point lying in the transitional region and accretion.

### LIST OF REFERENCE CHARACTERS

1 probe unit

11 probe electrode

12 insulation

2 electronics unit

3 container

4 medium

1-11. (canceled)

12. An apparatus for capacitive determining and/or monitoring at least of the fill level of a medium in a container, comprising:
a probe unit having at least one probe electrode; and
an electronics unit, which supplies at least said probe electrode with an electrical, transmitted signal, and receives and evaluates an electrical, response signal from said at least one probe unit, wherein:
said electronics unit supplies said at least one probe electrode at least at times by means of a frequency sweep with a transmitted signal, which has a plurality of discrete frequencies following one another within a predeterminable frequency band, said electronics unit, based on the frequency sweep, ascertains a measuring frequency optimal for present application parameters, and said electronics unit determines fill level from the response signal belonging to the optimal measuring frequency.

13. A method for capacitive determining and/or monitoring at least of the fill level of a medium in a container with a probe unit having at least one probe electrode, comprising the steps of:
supplying at least at time the probe electrode by means of a frequency sweep with an electrical, transmitted signal, which has a plurality of discrete exciter frequencies following one another within a predeterminable frequency band; and
based on the frequency sweep a measuring frequency optimal for present application parameters is ascertained; and
determining the fill level from a response signal of the probe electrode belonging to the optimal measuring frequency.

14. The method as claimed in claim 13, wherein:
the probe electrode is supplied continuously with the optimal measuring frequency for determining and/or monitoring fill level.

15. The method as claimed in claim 13, wherein:
for each frequency of the transmitted signal, from the associated response signal, the value of at least one characteristic variable of the response signal dependent on present application parameters and/or at least one dependent variable derived from at least one characteristic variable is ascertained and stored; and
that it is checked, when, for the frequency, at least one of the respectively ascertained characteristic variables and/or dependent variables fulfills at least one predetermined criterion for the presence of the optimal measuring frequency.

16. The method as claimed in claim 15, wherein:
especially phase shift between the transmitted signal and the response signal and/or admittance and/or magnitude of the response signal is/are ascertained as characteristic variable, and/or especially capacitance and/or fill level of the medium is/are ascertained as dependent variable derived from the characteristic variable.

17. The method as claimed in claim 15, wherein:
a criterion for exceeding- or subceeding a limit value is the presence of an extreme point, the assuming of a certain value or the presence of a certain slope.

18. The method as claimed in claim 15, wherein:
a criterion is that the frequency, in the case of which the associated value of one of the characteristic variables and/or dependent variables fulfills a certain criterion, is the highest frequency, for which this criterion is fulfilled.

19. The method as claimed in claim 15, wherein:
the time curve of at least one of the characteristic variables and/or dependent variables ascertained at a certain frequency is monitored.

20. The method as claimed in claim 14, wherein:
a breaking off of at least one part of the probe unit is detected by monitoring the frequency, at which resonances occur in the response signal.

21. The method as claimed in claim 12, wherein:
based on the frequency sweep, at least one present application parameter, preferably a parameter of the medium, especially the permittivity and/or the electrical conductivity of the medium, and/or the presence or the quantity of accretion of medium on the probe unit, is determined.
